(19) United States
(12) Patent Application Publication
(10) Pub. No.: US 2002/0193041 A1
(43) Pub. Date: Dec. 19, 2002

(54) Method of manufacturing a dispenser cathode for a cathode ray tube

(76) Inventors: Georg Friedrich Gaertner, Aachen (DE); Christopher James Goodhand, Blackburn (GB); Simon Nicholas Hodgson, Loughborough (GB); Andrew Peter Baker, Blackburn (GB)

Correspondence Address: U.S. Philips Corporation, 580 White Plains Road, Tarrytown, NY, 10591, US

(21) Appl. No.: 10/135,338

(22) Filed: Apr. 30, 2002

(30) Foreign Application Priority Data
May 2, 2001 (DE) 10121445.6

(51) Int. Cl. H01J 9/12

(52) U.S. Cl. 445/51

(57) ABSTRACT

Method of manufacturing a dispenser cathode for a cathode ray tube comprising a cathode carrier with a cathode base of a cathode metal and a metal matrix body of a matrix of metal particles of a metal selected from the group of refractory metals and, infiltrated into the matrix, oxide particles of an alkaline earth oxide selected from the group of oxides of calcium, strontium and barium, where the matrix of metal particles of a metal selected from the group of refractory metals is produced by reduction of a porous stabilized oxide gel of the metal selected from the group of refractory metals.

The invention relates to a method of manufacturing a dispenser cathode for a cathode ray tube which comprises a cathode carrier with a cathode base and a porous metal matrix body which is infiltrated with an electron-emitting material.

The functional groups of a cathode ray tube include an electron-emitting cathode which generates the electron flow in the cathode ray tube.

An electron-emitting cathode for a cathode ray tube is usually a heatable dispenser cathode with an electron-emitting, oxide-containing cathode body. When a dispenser cathode is heated, electrons are vaporized from the electron-emitting coating into the surrounding vacuum.

The quantity of electrons which can be emitted from the cathode coating depends on the work function of the electron-emitting material. Nickel, which is normally used as a cathode base, itself has a relatively high work function. Therefore the cathode base for a dispenser cathode is also fitted with a metal matrix body infiltrated with an electron-emitting material. Its main task is to improve the electron-emitting properties of the cathode base. One characteristic of the electron-emitting materials of dispenser cathodes is that they contain an alkaline earth metal in the form of an alkaline earth metal oxide.

To produce a dispenser cathode, a correspondingly formed metal matrix body is coated for example with the carbonates of the alkaline earth metals in a binding agent preparation. During evacuation and baking of the cathode ray tube, the carbonates are converted into the alkaline earth metal oxides at temperatures of around 1000° C. After this cathode burn-off, the cathode already emits a perceptible emission stream but this however is not yet stable. An activation process follows. This activation process converts the originally non-conductive ion lattice of the alkaline earth oxides into an electronic semi-conductor as donor-type impurities are integrated into the crystal lattice of the oxides. The impurities essentially consist of elementary alkaline earth metal e.g. calcium, strontium or barium. The electron emission of such dispenser cathodes is based on the impurity mechanism. The purpose of the activation process is to create a sufficient quantity of excess elementary alkaline earth metal via which the oxides in the electron-emitting coating can supply the maximum emission flow at a specified heating capacity. The reduction of barium oxide to elementary barium through alloy components (activators) of metal matrix bodies is an essential contribution to the activation process.

It is important for the function of a dispenser cathode and its life that fresh elementary alkaline earth metal is always available. During the life of the cathode the electron-emitting material constantly loses alkaline earth metal. Partly the cathode material overall vaporizes slowly, partly it is sputtered off by the ion current in the lamp.

However, at first elementary alkaline earth metal is continuously supplied. The supply however stops if over time, between the metal matrix body and the emitting oxide, a thin but high-resistance interface of alkaline earth silicate or alkaline earth aluminate forms.

U.S. Pat. No. 5,118,317 discloses a method of manufacturing of an impregnated dispenser cathode comprising a porous metal matrix body of a refractory metal serving as an activator, where the porous metal matrix body is formed by compaction of non-interlocking individual powder particles of transition metal coated with a thin layer of a ductile metal and subsequent sintering at a temperature below 600° C.

Such a cathode in which the metal matrix body is pressed from a metal powder and sintered has a better emission capacity and longer life as the porous structure of the metal matrix body supports the surface reaction between the activator metal and the actual emission material.

The object of the invention is to provide a method of manufacturing a dispenser cathode for a cathode ray tube, the beam current of which is uniform and remains constant over a long time, and which can be reproducibly manufactured.

According to the invention, the object is achieved by a method of manufacturing a dispenser cathode for a cathode ray tube which comprises a cathode carrier with a cathode base of a cathode metal and a metal matrix body of a matrix of metal particles of a metal selected from the group of the refractory metals and infiltrated into the matrix, oxide particles of an alkaline earth oxide selected from the group of oxides of calcium, strontium and barium, where the matrix is produced from metal particles of a metal selected from the group of refractory metals by reduction of a porous stabilized oxide gel of the metal selected from the group of refractory metals.

Such a dispenser cathode has a uniform beam current over a long period of time as the matrix has an open microstructure due to the method according to the invention. The improved surface properties lead firstly to an already high initial emission and secondly to a low poisoning resistance to oxygen. The open microstructure also increases the Ba retention.

The cathode is not susceptible to ion bombardment, has an even emission and can be manufactured reproducibly. Due to the continuous barium supply, exhaustion of the electron emission as occurs in conventional dispenser cathodes is avoided. Substantially higher current beam densities can be achieved without endangering the cathode life. It can also be utilized to draw the necessary electron beam currents flows from smaller cathode areas. The size of the cathode spot is decisive for the quality of beam focusing on the screen. Picture sharpness over the entire screen is increased. As, in addition, the cathodes are not subject to aging, the image brightness and sharpness can be kept stable at a high level over the entire life of the tube.

This wet chemical and/or aerosol-based process is more variable, more flexible and economic than the powder metallurgical processes conventionally used. This is due in particular to lower process temperatures below 1000° C. in comparison with the sintering and impregnation process above 1600° C. in the conventional method.

As part of the present invention it is preferred that the porous stabilized oxide gel of a refractory metal is produced by a reaction of a starting compound of the refractory metal with a microstructure control additive.

Preferred microstructure-control additives are a block copolymer R′R″R′(OH)₂, an emulsion, a reaction-modifying reagent and a polymer.

As part of the present invention it is preferred that the metal matrix body is produced with 20 to 80 vol % metal and 20 to 80 vol % oxide. Thus better adaptations are possible to different cathode applications in CRT's, high frequency and microwave tubes, X-ray tubes, thermionic converters, low and high pressure gas discharge lamps or the like.

If the refractory metal is selected from the group of Mg, Al, Fe, Si, Ti, Hf, Zr, W, Mo, Mn and Cr, the dispenser cathode is characterized by robust behavior on rapid switching.

The invention offers particularly advantageous effects in relation to the state of the art if the porous metal matrix body is coated with a cover layer containing a metal selected from the group Ir, Os, Re, Ru and W, by precipitation of the oxides or hydroxides of metals selected from the group Ir, Os, Re, Ru and W on the surface of the porous metal matrix and subsequent reduction to the metal.

According to another embodiment of the invention the porous metal matrix body can be coated with a cover layer containing a barium-calcium-aluminate.

The invention is explained in more detail below.

A cathode ray tube comprises an electron beam generating system which usually includes an arrangement with one or more dispenser cathodes.

A dispenser cathode according to the invention comprises a cathode carrier with a cathode base and a porous metal matrix body. The cathode carrier contains the heating and the base for the cathode body. The designs and materials known from the state of the art can be used for cathode carriers.

The material of the cathode base is usually a nickel alloy. The nickel alloy for the base of the dispenser cathode according to the invention can for example consist of nickel with an alloying proportion of a reducing activator element selected from the group silicon, magnesium, aluminum, tungsten, molybdenum, manganese and carbon.

The metal matrix body contains infiltrated oxide particles. The main components of the oxide particles are oxide particles of an alkaline earth oxide, preferably barium oxide, together with calcium oxide and/or strontium oxide. The alkaline earth oxides are used as a physical mixture of alkaline earth oxides or as binary or ternary mixed crystals of the alkaline earth metal oxides. A ternary alkaline earth mixed crystal oxide of barium oxide, strontium oxide and calcium oxide or a binary mixture of barium oxide and calcium oxide is preferred.

The alkaline earth oxide can contain a doping of an oxide selected from the oxides of scandium, yttrium and the lanthanoids lanthanum, cerium, praseodymium, neodymium, samarium, europium, gadolinium, terbium, dysprosium, holmium, erbium, thulium, ytterbium and lutetium, e.g. in a quantity of 10 to a maximum 1000 ppm.

The metal matrix body also contains a matrix of metal particles of a metal selected from the group of refractory metals Mg, Al, Fe, Si, Ti, Hf, Zr, W, Mo, Mn and Cr.

The components of the porous metal matrix are arranged in a particle-particle composite with open pores. Particularly advantageous effects in relation to the state of the art are given by a dispenser cathode according to the invention with a particle-particle composite in which the pore dimensions have a gradient towards the surface. In this dispenser cathode the Ba retention is particularly improved.

The microstructure of the metal matrix can also be improved further if the metal particles have a transition from one metal to another in a longitudinal direction.

The porous metal matrix can also contain a coating. For example the porous metal matrix can be covered with a cover layer which contains one of the metals Ir, Os, Re, Ru or W or a combination thereof. This layer can be formed by the precipitation of the corresponding oxides or oxide hydrates on the surface of the metal matrix and subsequent reduction to metals. This gives preferably a cover layer with a thickness of 1 to 30 μm with pores in the submicron range.

The porous metal matrix can also be coated with a cover layer containing oxide particles of an alkaline earth oxide selected from the group of oxides of calcium, strontium and barium and oxide particles of an oxide selected from the group of oxides of scandium, yttrium and the lanthanoids.

In the cover layer with pores in the submicron range a rapid lateral diffusion supply of barium to the surface of the dispenser cathode occurs as the lateral dimensions are smaller than the diffusion lengths. This leads to longer life and low operating temperatures for the dispenser cathode. If the cover layer is produced by precipitation of the corresponding oxides or oxide hydrates on the surface of the metal matrix and subsequent reduction to the metals, in the cover layer a continuous transition can be achieved from course pores to fine pores in the direction of the emitting surface, which guarantees a good barium supply even under ion bombardment and simultaneously reduces the barium vaporization due to the low operating temperature.

The matrix of metal particles of a metal selected from the group of the refractory metals is produced by reduction of an oxide gel of the metal selected from the group of refractory metals. The refractory metals comprise the refractory metals Mg, Al, Fe, Si, Ti, Hf, Zr, W, Mo, Mn and Cr.

Chemical starting compounds serve as the start for the metal oxide phase. These can for example be halogenides, carbonyls, alcoholates or metal hydroxides. To form a matrix from tungsten for example WCl₆, W(CO)₆, W(OC₂H₅)₆ or H₂WO₄ can be used and for a matrix of nickel NiCl₄. These compounds are brought into solution, preferably an alcoholic solution. In a homogeneous reaction, they are reacted with microstructure-control additives. These microstructure control additives can be block copolymers R′R″R′(OH)₂, emulsions e.g. oil-water emulsions, reaction-modifying reagents and polymers. The reaction leads to the corresponding oxides and oxide hydrates as gels with controlled microstructure and morphology. The oxide gel is then reacted with a reducing agent for example with 5% in nitrogen-hydrogen at 500 to 1000° C., in order to obtain a porous metal matrix with controlled microstructure and morphology.

Particularly preferred is a production process in which block polymers R′R″R′(OH)₂ act as “molecular templates” which cause a pseudo-sol-gel precipitation and stabilize the oxide gels.

The following reactions then take place:

(a) MClₓ+H₂O→M(OH)ₓ+x HCl (not modified)

(a2) M(OH)ₓ→MO_{x/2}+x/2 H₂O (precipitation)

(b1) MClₓ+(y) HOR′R″R′OH→MCl_{x-(y/2)}OR′R″R′O_{y}+x HCl (stabilized)

(b2) MCl_{x-(y/2)}OR′R″R′O_{y}+xH₂O→M(OH)ₓ+(y)R′R″R′(OH)₂+(x−2) HCl (“templated”)

(b3) M(OH)ₓ→MO_{x/2}+x/2H₂=(porous gel)

The pore distribution of the oxide gel with controlled microstructure and porosity is determined for example by the drop characteristics of the original emulsion. Oil and other organic components of the emulsion are then removed by a first temperature treatment at 400 to 600° C. The porous oxide gel is then converted via reduction with a hydrogen-nitrogen mixture at 500 to 1000° C. into a porous metal matrix with controlled microstructure and porosity.

After production of the microstructured porous metal matrix, which can also have a gradient of pore dimensions towards the surface or a transition to another metal, a conventional infiltration, a gel or a wet chemical infiltration technique can be used to fill the pores of the metal matrix with barium-calcium-aluminate or another barium-oxide-containing material.

To produce the raw material for infiltration of oxide particles, the carbonates of the alkaline earth metals calcium, strontium and barium are ground and mixed together and where applicable mixed with a starting compound for the oxide of scandium, yttrium, lanthanum, cerium, praseodymiumn, neodymium, samarium, europium, gadolinium, terbium, dysprosium, holmium, erbium, thulium, ytterbium and lutetium in the required weight ratio. Preferred starting compounds for the oxides of scandium, yttrium and the lanthanoids are the nitrates or hydroxides of these elements.

Typically the weight ratio of calcium carbonate: strontium carbonate: barium carbonate is 1:1.25:6 or 1:12:22 or 1:1.5:2.5 or 1:4:6.

In order to dope the oxides of the alkaline earth metals with the oxides of scandium, yttrium, lanthanum, cerium, praseodymium, neodymium, samarium, europium, gadolinium, terbium, dysprosium, holmium, erbium, thulium, ytterbium and lutetium, the carbonates of the alkaline earth metals can be co-precipitated with the nitrates of scandium, yttrium and the lanthanoids.

The raw material can also be mixed with a binding agent preparation. The binding agent preparation can contain as a solvent water, ethanol, ethylnitrate, ethylacetate or diethylacetate.

It is infiltrated into the metal matrix by brushing, dipping, cataphoretic precipitation or spraying.

It is also possible to produce the dispenser cathode in an integrated process in which the matrix preparation and oxide infiltration take place in the same step. In this case the differential oxide stabilities of the refractory metals and alkaline earth metals allow formation of the metal phase in situ.

The dispenser cathode is integrated into the cathode ray tube. During evacuation of the cathode ray tube the dispenser cathode is formed. By heating to around 650 to 1100° C. the alkaline earth carbonates are converted into alkaline earth oxides while releasing CO and CO₂ and then form a porous sinter compound. The crystallographic change by mixed crystal formation, which is a prerequisite for a good dispenser cathode, is essential in this conversion process. After this cathode “burn-off”, activation takes place with the purpose of supplying excess elementary alkaline earth metal embedded in the oxides. The excess alkaline earth metal is obtained through reduction of alkaline earth metal oxide. In the actual reduction activation, the alkaline earth oxide is reduced by the released CO or activator metal from the cathode base and the metal matrix. Then current activation takes place which generates the necessary free alkali earth metals by electrolytic processes at high temperatures.

The production process according to the invention is an efficient method for composite cathode body structures with gradients in material and structure, for example in the form of metal lattice structures e.g. of Ni, porous metal matrices e.g. of tungsten, or metal components which contain activators for barium release. It also comprises the spray deposition of complex-composition dispenser cathode structures with functional gradients in conjunction with molecular self-assembly techniques based on emulsion and foaming methods. Typical examples of structures which can be produced with the process according to the invention are sprayed dispenser cathode layer structures with Ni particle single layers, dispenser cathodes with double layers in the metal matrix, foamed metal matrix structures and porous metal matrix structures with controlled porosity. It is also possible to align elongated Ni particle chains via a magnetic field.

1. Method of manufacturing a dispenser cathode for a cathode ray tube which comprises a cathode carrier with a cathode base of a cathode metal and a metal matrix body of a matrix of metal particles of a metal selected from the group of refractory metals, and, infiltrated into the matrix, oxide particles of an alkaline earth oxide selected from the group of oxides of calcium, strontium and barium, where the matrix of metal particles of a metal selected from the group of refractory metals is produced by reduction of a porous stabilized oxide gel of the metal selected from the group of refractory metals.

2. Method of manufacturing a dispenser cathode for a cathode ray tube as claimed in claim 1, characterized in that the porous stabilized oxide gel of a refractory metal is produced by reaction of a starting compound of the refractory metal with a microstructure control additive.

3. Method of manufacturing a dispenser cathode for a cathode ray tube as claimed in claim 1, characterized in that as a microstructure-control additive a block copolymer R′R″R′(OH)₂ an emulsion, a reaction-modifying reagent and a polymer are used.

4. Method of manufacturing a dispenser cathode for a cathode ray tube as claimed in claim 1, characterized in that the metal matrix body is produced with 20 to 80 vol % metal and 20 to 80 vol % oxide.

5. A method of manufacturing a dispenser cathode for a cathode ray tube as claimed in claim 1, characterized in that the refractory metal is selected from the group Mg, Al, Fe, Si, Ti, Hf, Zr, W, Mo, Mn and Cr.

6. Method of manufacturing a dispenser cathode for a cathode ray tube as claimed in claim 1, characterized in that the porous metal matrix body is coated with a cover layer containing a metal selected from the group Ir, Os, Re, Ru and W by precipitation of oxides or hydroxides of the metals selected from the group Ir, Os, Re, Ru and W on the surface of the porous metal matrix and subsequent reduction to metal.

7. Method of manufacturing a dispenser cathode for a cathode ray tube as claimed in claim 1, characterized in that the porous metal matrix body is coated with a cover layer containing a barium-calcium-aluminate.
